(19) United States
(12) Patent Application Publication
(10) Pub. No.: US 2016/0101433 A1
(43) Pub. Date: Apr. 14, 2016

(54) LASER PRE-PROCESSING TO STABILIZE HIGH-TEMPERATURE COATINGS AND SURFACES

(71) Applicant: SIEMENS ENERGY, INC., ORLANDO, FL (US)

(72) Inventors: Gerald J. Bruck, Oviedo, FL (US); Ahmed Kamel, Orlando, FL (US)

(21) Appl. No.: 14/513,578

(22) Filed: Oct. 14, 2014

(51) Int. Cl. B05D 3/02; C22C 45/04; C22C 19/07; B05D 7/14; B23K 26/00; C22C 19/03; B32B 15/01; C22C 1/00

(52) U.S. Cl. CPC B05D 3/0218; B32B 15/01; C22C 45/04; C22C 1/002; B05D 7/14; B23K 26/0012; B23K 26/0072; C22C 19/03; C22C 19/07

(57) ABSTRACT

Laser pre-processing to stabilize high-temperature coatings and surfaces. One method involves melting a surface of a metal substrate (2) with an energy beam (22) to form a melt pool (24), allowing the melt pool to cool and solidify into a melt-processed alloy layer (28) bonded to the metal substrate, and coating the melt-processed alloy layer with a protective alloy layer (4) to form a coated substrate. A flux composition (18) may also be deposited onto the surface of the metal substrate, such that the melt processing also forms a slag layer (30) at least partially covering the melt-processed alloy layer. A protective material (34) containing a carbon source may also be deposited onto the surface of the metal substrate, such that the melt processing forms a carbon-enriched melt-processed alloy layer (36) having a higher proportion of carbon than the metal substrate.

### FIELD OF THE INVENTION

This application relates to materials technology in general and more specifically to laser pre-processing of metal surfaces in order to stabilize the metal surfaces and coatings applied thereto from developing phase instabilities.

### BACKGROUND OF THE INVENTION

Hot section components of modern gas turbine engines are often made of high-temperature alloys including superalloys based on nickel, iron and cobalt. These superalloys have been developed to withstand increasingly higher operating temperatures as well as the presence of corrosive and oxidative conditions. To withstand these extreme environments, protective coating systems are often applied to the surface of superalloy components. These coating systems include an environmental coating, which can also serve as a bond coat, and usually a thermal barrier coating (TBC) overlying the environmental or bond coat.

Such environmental coatings (or bond coats) are typically metallic overlay coatings of the formula “MCrAIX” (where M is a Group VIIIB element such as Co, Ni, or a mixture thereof, and X is a rare earth element such as Y, Hf, W, Zr, La, or a mixture thereof) or diffusion aluminide coatings such as NiAI or a modified NiAI that includes an element such as Pt, Rh or Pd. In thermal barrier coating (TBC) systems containing both a bond coat and a TBC layer, the TBC layer is often formed from metal oxides such as yttria-stabilized zirconias (YSZs).

The performance of superalloys and environmental coatings can, in some instances, be limited by detrimental phase instabilities that may occur over time during use at elevated temperatures. These phase instabilities can occur within the bulk alloy of the substrate itself (as bulk-metal instabilities) or as surface instabilities near the interface with an environmental coating. Nickel-based superalloys such as Alloy 625, for instance, can become embrittled over time due to bulk instabilities resulting from the formation of a delta phase (Ni₃Cb) at elevated temperatures. Other superalloys such as Alloy 617 are prone to superficial embrittlement over time due to the formation of titanium nitride caused by nitrogen diffusion (from air) into the surface of the alloy matrix at elevated temperatures.

Phase instabilities can also occur due to diffusion between the environmental coating and the superalloy substrate. The bond coat materials described above contain relatively high amounts of aluminum relative to the superalloys they protect, and the superalloys often contain various elements that are not present (or are present in relatively small amounts) in the bond coat. Therefore, during formation and operation of the bond coat, inter-diffusion of bond coat materials with the underlying alloy substrate can result in the formation of topologically closed-packed (TCP) phases which, if present in sufficiently high concentrations, can drastically affect the load-bearing properties of the alloy. TCP phases are intermetallic precipitates (e.g., inclusions) that are rich in refractory elements such as W, Mo and Re and which tend to form over time in Ni-based superalloys. It is well known that the presence of TCP phases can lead to degraded properties by serving as sites for crack initiation, and by reducing the presence of strengthening elements in the surrounding alloy matrix.

In some high-strength superalloys containing significant amounts of refractory elements (e.g., Re, W, Ta, Hf, Mo, Nb and Zr) the inter-diffusion of bond coat materials with the underlying alloy substrate can result in the formation of a secondary reaction zone (SRZ) in which detrimental TCP phases can form. A secondary reaction zone (SRZ) is an intermediate layer formed between an aluminized or Pt-aluminized coating and the superalloy substrate by a discontinuous precipitation process that is similar to recrystallization.

FIG. 1 shows a schematic illustration of a SRZ 12 which is formed beneath the interdiffusion zone 8 of an aluminide coating 6 bonded to a superalloy substrate 2. The aluminide coating 6 and the interdiffusion zone 8 together form a diffusion aluminide coating 4 which can serve as an environmental coating, or alternatively as a bond coat when bonded to an outermost TBC (not shown). The interdiffusion zone 8 contains TCP phases 10 which can jeopardize the integrity of the environmental covering 4 if their concentration or size becomes too large. The SRZ 12 contains elongated TCP phases 14 which are known to initiate cracking and to reduce the load bearing cross section of the environmental coating 4 leading to degraded rupture strength.

The problem of SRZ formation and loss of mechanical integrity can be especially profound in single-crystal alloys (e.g., Rene N5, Rene N6, CMSX-4, CMSX-10 and CMXS-12) that are coated with platinum aluminide layers. There are two types of platinum-aluminide coatings—two-phase and one phase. Two-phase coatings contain a layer of platinum-aluminide particles (PtAl₂) on the surface and a nickel-aluminide plus platinum layer, (Ni, Pt)Al), underneath. One-phase coatings contain only the nickel-aluminide plus platinum layer.

Various strategies have been attempted to mitigate the adverse effects of SRZ formation in superalloy components. First, a number of mechanical strategies have been investigated involving surface preparation of the substrate to reduce or eliminate SRZ formation. For example, it is known that electropolishing of the substrate prior to aluminizing can effectively reduce or eliminate SRZ formation. See, e.g., US 2010/0260613. More intense surface preparation such as light grinding tends to produce inconsistent results, and very aggressive surface preparation such as shot peening produces consistently poor results. The cold work from aggressive surface treatments evidently promotes nucleation and SRZ formation; whereas electropolishing appears to remove such cold work.

A second strategy attempted to mitigate SRZ formation involves compositional modification. It is known, for example, that sputter deposition of pure nickel prior to aluminizing the superalloy substrate can reduce SRZ formation. See, e.g., US 2008/0193663. It is also known that chemical vapor deposition of carbides can reduce SRZ formation by tying up refractory elements such as W and Ta as metal carbides and thereby reducing the driving force for SRZ formation. See, e.g., U.S. Pat. No. 5,334,263. Such carbides can also inhibit the movement and growth of SRZ colonies.

### BRIEF DESCRIPTION OF THE DRAWINGS

The invention is explained in the following description in view of the drawings that show:

FIG. 1 is a schematic illustration of a prior art aluminide-coated superalloy substrate containing a secondary reaction zone (SRZ).

FIG. 2 illustrates a coating method in which laser pre-processing of a superalloy substrate produces an amorphous layer of the superalloy metal bonded to the superalloy substrate.

FIG. 3 illustrates a multi-layer coating resulting from a coating method involving laser pre-processing of a superalloy substrate to form a melt-processed superalloy layer bonded to the superalloy substrate.

FIG. 4 illustrates a coating method in which laser pre-processing of a superalloy substrate produces a carbon-enriched alloy layer bonded to the superalloy substrate.

### DETAILED DESCRIPTION OF THE INVENTION

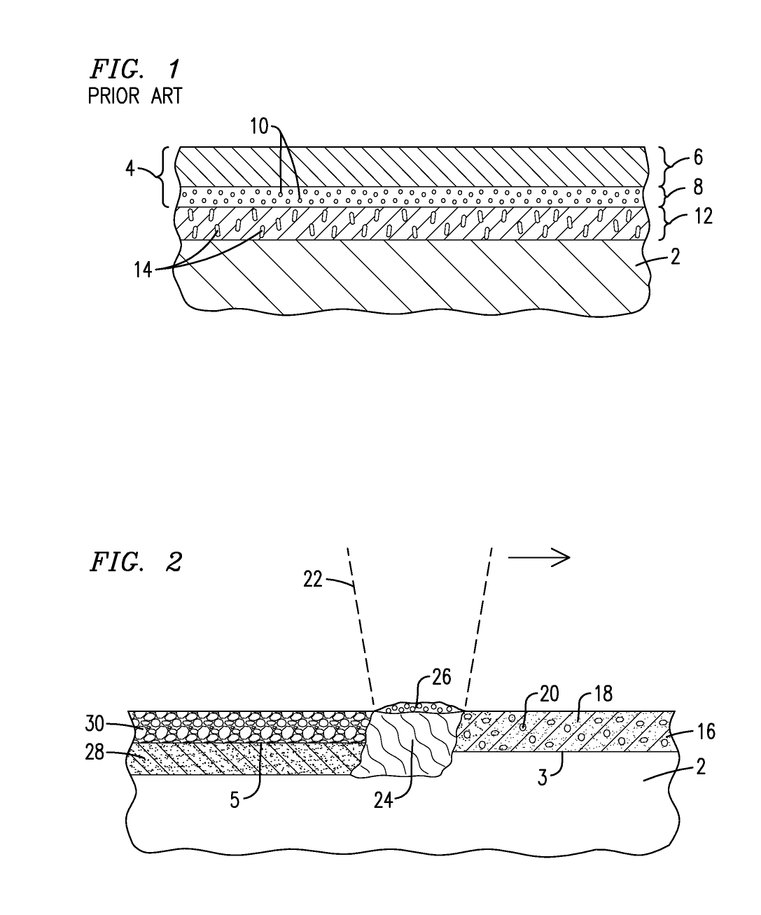

Electro-polishing, sputter deposition and chemical vapor deposition are very costly and time consuming methods which are not practical for commercial applications—most especially in the processing of large turbine airfoils. Applicants have recognized that a need exists to discover alternative strategies and methods for reducing or eliminating the adverse effects of secondary reaction zone (SRZ) formation in superalloy components. An ideal method would prevent the formation of the SRZs depicted in FIG. 1 by performing a fast and simple surface modification of vulnerable superalloys which does not require the use of expensive materials or air-free conditions.

The present disclosure proposes alternative methods and materials for reducing the occurrence of SRZs in superalloy components by pre-processing the surface of superalloy substrates with at least one energy beam (such as a laser beam) in order to modify their physical and/or chemical properties. Some embodiments involve laser glazing the surface of superalloy substrates, prior to the application of at least one protective layer, in order to remove thermal stresses and/or physical asperities that can lead to SRZ formation. Other embodiments involve laser glazing of the substrate surface in the presence of a protective material containing a carbon source, prior to the application of at least one protective layer, in order to carbon enrich the surface of the superalloy substrate and thereby reduce or eliminate SRZ formation.

The term “superalloy” is used herein in a general sense to describe a highly corrosion and oxidation resistant alloy that exhibits excellent mechanical strength and resistance to creep at high temperatures, as well as good surface stability. Superalloys typically include a base alloying element of nickel, cobalt or nickel-iron. Examples of superalloys include alloys sold under the trademarks and brand names such as Hastelloy, Inconel alloys (e.g. IN 100, IN 617, IN 625, IN 700, IN 713C, IN 738, IN 792, IN 939), Rene alloys (e.g. Rene N5, Rene 41, Rene 80, Rene 108, Rene 142, Rene 220), Haynes alloys (282), 10 Mar M, CM 247, CM 247 LC, C263, 718, X-750, ECY 768, 282, X45, PWA 1480, PWA 1483, PWA 1484, CMSX single crystal alloys (e.g., CMSX-4, CMSX-8, CMSX-10), GTD 111, GTD 222, MGA 1400, MGA 2400, PSM 116, Mar-M-200, Udimet 600, Udimet 500 and titanium aluminide. The term “metal” is used herein in a general sense to describe pure metals, semi-pure metals and metal alloys.

FIG. 2 depicts one embodiment of the present disclosure wherein a surface 3 of a superalloy substrate 2 is melted with an energy beam 22 to form a melt pool 24 which is then allowed to cool and solidify into a melt-processed superalloy layer 28 bonded to the superalloy substrate 2. In this non-limiting illustration the surface 3 is a rough surface containing physical asperities that can ultimately lead to SRZ formation in a diffusion-coated component. These surface asperities are removed by the pre-processing (glazing) such that the new surface 5 of the melt-processed superalloy layer 28, which is bonded to the underlying superalloy substrate 2, is free of the physical asperities. Thermal stresses (not shown) that may be contained at or near the surface 3 of the superalloy substrate 2 are also removed by performing the pre-processing (glazing) of FIG. 2.

The melt-processed superalloy layer 28 may then be coated with at least one protective alloy layer to form a protective coating imparting at least one protective characteristic (such as temperature resistance and/or chemical resistance) to a component fabricated from the coated superalloy.

The term “energy beam” is used herein in a general sense to describe a relatively narrow, propagating stream of particles or packets of energy. An energy beam 22 as used in this disclosure may include a light beam, a laser beam, a particle beam, a charge-particle beam, a molecular beam, etc., which upon contact with a material imparts kinetic (thermal) energy to the material.

In some embodiments the energy beam 22 is a diode laser beam having a generally rectangular cross-sectional shape, although other known types of energy beams may be used, such as electron beam, plasma beam, one or more circular laser beams, a scanned laser beam (scanned one, two or three dimensionally), an integrated laser beam, a pulsed (versus continuous wave) laser beam, etc. The rectangular shape may be particularly advantageous for embodiments having a relatively large area to be melted. In some embodiments the intensity and shape of the energy beam 22 are precisely controlled by employing laser scanning (rastering) optics to form a melt pool 24 having a precisely defined size and shape.

Unlike previously-described methods for reducing SRZ formation, such as electro-polishing, the method of FIG. 1 advantageously allows the depth of the melt pool 24 to be controlled by altering the processing parameters. For example, when the energy beam is a laser beam the depth of the melt pool 24 may be controlled by altering the energy intensity, focal point and/or frequency of the laser photons. Suitable laser sources may include, for example, lower power lasers (e.g., 503 nm and 1.06 μm Nd:YAG lasers) and higher power lasers (e.g., 1.06 μm ytterbium fiber, 5.4 μm CO and 10.6 μm CO₂ lasers)—depending upon the amount of laser energy intensity required to obtain a desired melt pool depth. Other processing parameters such as the scanning (traversing) rate or the pulsing rate (i.e., for a pulsed laser beam) may also be adjusted to increase or decrease the depth of the resulting melt pool 24.

In some embodiments the superalloy substrate 2 of FIG. 2 may have a crystalline solid structure such as an equiaxed crystal structure, a directionally-solidified crystal structure or a single crystal structure. In the non-limiting illustration of FIG. 2 the superalloy substrate 2 is a single crystal structure, and the melting and re-solidification of the surface 3 causes the melt-processed superalloy layer 28 to have an amorphous solid structure. While not being bound by any particular theory or mechanism, it is believed that such embodiments wherein the re-solidified metal is amorphous may further reduce the formation of SRZs in a subsequently-formed multi-layer coating by removing initiation points that can lead to elongated TCP phases 14.

The amorphous structure 28 of FIG. 2 may be obtained by adjusting the processing parameters (as described above) to obtain a relatively shallow melt pool 24 which forms a very thin melt-processing superalloy layer 28. A very thin melt-processed superalloy layer 28 may be obtained, for example, by melting the surface of the superalloy substrate 2 using a high power density applied at a high processing speed—which produces a short-lived superficial melt pool 24 that re-solidifies very quickly to produce a non-crystalline (amorphous) solid structure. In other embodiments the processing parameters may be altered to produce a relatively long-lived melt pool 24 which re-crystallizes more slowly to produce a crystalline solid structure that may emulate an initial crystalline structure of the underlying superalloy substrate 2.

In some non-limiting embodiments it may be necessary or otherwise advantageous to conduct the method of FIG. 2 under an atmosphere containing a reduced amount of oxygen and/or nitrogen, in order to avoid the formation of impurities such as metal oxide and nitrides. In such cases the pre-processing (glazing) may be performed under vacuum conditions (inside a vacuum chamber) or under an inert gas such as helium or argon (inside a gas chamber or outside under an inert gas blanket formed with a continuous flow of the inert gas). Alternatively, or in addition thereto, the pre-processing (glazing) may also be performed in the presence of a flux composition deposited onto the surface of the superalloy substrate and/or directed into the melt pool.

FIG. 2 also illustrates the optional use of a flux layer 16 deposited onto the surface 3 of the superalloy substrate 2, wherein the melting of the surface of the superalloy substrate 2 also melts a flux composition 18 contained in the flux layer 16. Cooling of the flux-containing melt pool 24 forms both the melt-processed superalloy layer 28 and a slag layer 30 at least partially covering the melt-processed superalloy layer 28. The slag layer 30 may then be removed using mechanical methods (e.g., chipping, scraping, grinding) and/or chemical methods depending upon the nature of the superalloy and the constituents of the flux composition.

The flux composition 18 and the resulting slag layer 30 provide a number of beneficial functions that can improve the chemical and/or mechanical properties of coated superalloys of the present disclosure.

First, the flux composition 18 and the resulting slag layer 30 can both function to shield both the region of the melt pool 24 and the solidified (but still hot) melt-processed layer 28 from the atmosphere. The slag floats to the surface to separate the molten or hot metal from the atmosphere and the flux composition may be formulated to produce at least one shielding agent 20 which generates at least one shielding gas upon exposure to laser photons or heating. In some embodiments shielding gases may coalesce into a gaseous envelope 26 covering the melt pool 24, as illustrated in FIG. 2. Shielding agents 20 include metal carbonates such as calcium carbonate (CaCO₃), aluminum carbonate (Al₂(CO₃)₃), dawsonite (NaAl(CO₃)(OH)₂), dolomite (CaMg(CO₃)₂), magnesium carbonate (MgCO₃), manganese carbonate (MnCO₃), cobalt carbonate (CoCO₃), nickel carbonate (NiCO₃), lanthanum carbonate (La₂(CO3)₃) and other agents known to form shielding and/or reducing gases (e.g., CO, CO₂, H₂). The presence of the slag layer 30 and the optional shielding gas 20 can avoid or minimize the need to conduct melt processing in the presence of inert gases (such as helium and argon) or within a sealed chamber (e.g., vacuum chamber or inert gas chamber) or using other specialized devices for excluding air.

Second, the slag layer 30 can act as an insulation layer that allows the resulting melt-processed layer 28 to cool slowly and evenly, thereby reducing residual stresses that can contribute to post weld cracking, reheat or strain age cracking, and secondary reaction zone formation. Such slag blanketing over and adjacent to the deposited metal layers can further enhance heat conduction towards the superalloy substrate 2 which in some embodiments can promote directional solidification to form elongated (uniaxial) grains in the melt-processed layer 28.

Third, the slag layer 30 can help to shape and support the melt pool 24 to keep them close to a desired height/width ratio (e.g., a ⅓ height/width ratio). This shape control and support further reduces solidification stresses that could otherwise be imparted to the melt-processed layer 28. Along with shape and support, the slag layer can also be produced from flux that is formulated to enhance surface smoothness of the glazed layer—thereby reducing secondary reaction zone formation.

Fourth, the flux composition 18 and the slag layer 24 can provide a cleansing effect for removing trace impurities that contribute to inferior properties. Such cleaning may include deoxidation of the melt pool 24. Some flux compositions may also be formulated to contain at least one scavenging agent capable of removing unwanted impurities from the melt pool. Scavenging agents include metal oxides and fluorides such as calcium oxide (CaO), calcium fluoride (CaF₂), iron oxide (FeO), magnesium oxide (MgO), manganese oxides (MnO, MnO₂), niobium oxides (NbO, NbO₂, Nb₂O₅), titanium oxide (TiO₂), zirconium oxide (ZrO₂), and other agents known to react with detrimental elements such as sulfur and phosphorous and elements known to produce low melting point eutectics to form low-density byproducts expected to “float” into a resulting slag layer 30.

Fifth, the flux composition 18 and the slag layer 30 can increase the proportion of thermal energy delivered to the surface 8 of the superalloy substrate 2. This increase in heat absorption may occur due to the composition and/or form of the flux composition 2. In terms of composition the flux may be formulated to contain at least one compound capable of absorbing laser energy at the wavelength of a laser energy beam used as the energy beam 22. Increasing the proportion of a laser absorptive compound causes a corresponding increase in the amount of laser energy (as heat) applied to the surface 3. This increase in heat absorption can provide greater versatility by allowing the use of smaller and/or lower power laser sources that may be capable of producing a relatively shallower melt pool 24—which may be useful, for example, in controlling the formation an amorphous melt-processed layer 28. In some cases the laser absorptive compound could also be an exothermic compound that decomposes upon laser irradiation to release additional heat.

The form of the flux composition 18 can also affect laser absorption by altering its thickness and/or particle size. In such cases absorption of laser heating generally increases as the thickness of the layer 16 of the flux composition 18 increases. Increasing the thickness of the flux layer 16 also increases the thickness of a resulting molten slag blanket, which can further enhance absorption of laser energy. The thickness of the flux layer 16 in methods of the present disclosure typically ranges from about 1 mm to about 15 mm. In some cases the thickness ranges from about 3 mm to about 12 mm, while in other instances the thickness ranges from about 5 mm to about 10 mm.

Reducing the average particle size of the flux composition 18 also causes an increase in laser energy absorption (presumably through increased photon scattering within the bed of fine particles and increased photon absorption via interaction with increased total particulate surface area). In terms of the particle size, whereas commercial fluxes generally range in average particle size from about 0.5 mm to about 2 mm (500 to 2000 microns) in diameter (or approximate dimension if not rounded), flux composition in some embodiments of the present disclosure range in average particle size from about 0.005 mm to about 0.10 mm (5 to 100 microns) in diameter. In some cases the average particle size ranges from about 0.01 mm to about 5 mm, or from about 0.05 mm to about 2 mm. In other cases the average particle size ranges from about 0.1 mm to about 1 mm in diameter, or from about 0.2 mm to about 0.6 mm in diameter.

Additionally, the flux composition 18 may be formulated to compensate for loss of volatilized or reacted elements during processing or to actively contribute elements to the melt-processed layer 28 that are not otherwise contained in the superalloy substrate 2. Such vectoring agents include titanium, zirconium, boron and aluminum containing compounds and materials such as titanium alloys (Ti), titanium oxide (TiO₂), titanite (CaTiSiO₅), aluminum alloys (Al), aluminum carbonate (Al₂(CO₃)₃), dawsonite (NaAl(CO₃)(OH)₂), borate minerals (e.g., kernite, borax, ulexite, colemanite), nickel titanium alloys (e.g., Nitinol), niobium oxides (NbO, NbO₂, Nb₂O₅) and other metal-containing compounds and materials used to supplement molten alloys with elements. Certain oxometallates as described below can also be useful as vectoring agents.

Flux compositions of the present disclosure may include one or more inorganic compounds selected from metal oxides, metal halides, metal oxometallates and metal carbonates. Such compounds may function as (i) optically transmissive vehicles; (ii) viscosity/fluidity enhancers; (iii) shielding agents; (iv) scavenging agents; and/or (v) vectoring agents.

Suitable metal oxides include compounds such as Li₂O, BeO, B₂O₃, B₆O, MgO, Al₂O₃, SiO₂, CaO, Sc₂O₃, TiO, TiO₂, Ti₂O₃, VO, V₂O₃, V₂O₄, V₂O₅, Cr₂O₃, CrO₃, MnO, MnO₂, Mn₂O₃, Mn₃O₄, FeO, Fe₂O₃, Fe₃O₄, CoO, Co₃O₄, NiO, Ni₂O₃, Cu₂O, CuO, ZnO, Ga₂O₃, GeO₂, As₂O₃, Rb₂O, SrO, Y₂O₃, ZrO₂, NiO, NiO₂, Ni₂O₅, MoO₃, MoO₂, RuO₂, Rh₂O₃, RhO₂, PdO, Ag₂O, CdO, In₂O₃, SnO, SnO₂, Sb₂O₃, TeO₂, TeO₃, Cs₂O, BaO, HfO₂, Ta₂O₅, WO₂, WO₃, ReO₃, Re₂O₇, PtO₂, Au₂O₃, La₂O₃, CeO₂, Ce₂O₃, and mixtures thereof, to name a few.

Suitable metal halides include compounds such as LiF, LiCI, LiBr, LiI, Li₂NiBr₄, Li₂CuCl₄, LiAsF₆, LiPF₆, LiAlCl₄, LiGaCl₄, Li₂PdCl₄, NaF, NaCl, NaBr, Na₃AlF₆, NaSbF₆, NaAsF₆, NaAuBr₄, NaAlCl₄, Na₂PdCl₄, Na₂PtCl₄, MgF₂, MgCl₂, MgBr₂, AlF₃, KCl, KF, KBr, K₂RuCl₅, K₂IrCl₆, K₂PtCl₆, K₂PtCl₆, K₂ReCl₆, K₃RhCl₆, KSbF₆, KAsF₆, K₂NiF₆, K₂TiF₆, K₂ZrF₆, K₂Ptl₆, KAuBr₄, K₂PdBr₄, K₂PdCl₄, CaF₂, CaF, CaBr₂, CaCl₂, Cal₂, ScBr₃, ScCl₃, ScF₃, ScI₃, TiF₃, VCl₂, VCl₃, CrCl₃, CrBr₃, CrCl₂, CrF₂, MnCl₂, MnBr₂, MnF₂, MnF₃, Mnl₂, FeBr₂, FeBr₃, FeCl₂, FeCl₃, Fel₂, CoBr₂, CoCl₂, CoF₃, CoF₂, Col₂, NiBr₂, NiCl₂, NiF₂, Nil₂, CuBr, CuBr₂, CuCl, CuCl₂, CuF₂, Cul, ZnF₂, ZnBr₂, ZnCl₂, Znl₂, GaBr₃, Ga₂Cl₄, GaCl₃, GaF₃, GaI₃, GaBr₂, GeBr₂, GeI₂, GeI₄, RbBr, RbCl, RbF, RbI, SrBr₂, SrCl₂, SrF₂, SrI₂, YCl₃, YF₃, YI₃, YBr₃, ZrBr₄, ZrCl₄, ZrI₂, YBr, ZrBr₄, ZrCl₄, ZrF₄, ZrI₄, NbCl₅, NbF₅, MoCl₃, MoCl₅, Ruh, RhCl₃, PdBr₂, PdCl₂, PdI₂, AgCl, AgF, AgF₂, AgSbF₆, AgI, CdBr₂, CdCl₂, CdI₂, InBr, InBr₃, InCl, InCl₂, InCl₃, InF₃, InI, InI₃, SnBr₂, SnCl₂, Snl₂, Snl₄, SnCl₃, SbF₃, SbI₃, CsBr, CsCl, CsF, CsI, BaCl₂, BaF₂, Bal₂, BaCoF₄, BaNiF₄, HfCl₄, HfF₄, TaCl₅, TaF₅, WCl₄, WCl₆, ReCl₃, ReCl₅, IrCl₃, PtBr₂, PtCl₂, AuBr₃, AuCl, AuCl₃, AuI, KAuCl₄, LaBr₃, LaCl₃, LaF₃, LaI₃, CeBr₃, CeCl₃, CeF₃, CeF₄, CeI₃, and mixtures thereof, to name a few.

Suitable oxometallates include compounds such as LiIO₃, LiBO₂, Li₂SiO₃, LiClO₄, Na₂B₄O₇, NaBO₃, Na₂SiO₃, NaVO₃, Na₂MoO₄, Na₂SeO₄, Na₂SeO₃, Na₂TeO₃, K₂SiO₃, K₂CrO₄, K₂Cr2O₇, CaSiO₃, BaMnO₄, and mixtures thereof, to name a few.

Suitable metal carbonates include compounds such as Li₂CO₃, Na₂CO₃, NaHCO₃, MgCO₃, K₂CO₃, CaCO₃, Cr₂(CO₃)₃, MnCO₃, CoCO₃, NiCO₃, CuCO₃, Rb₂CO₃, SrCO₃, Y₂(CO3)₃, Ag₂CO₃, CdCO₃, In₂(CO₃)₃, Sb₂(CO₃)₃, C₂CO₃, BaCO₃, La₂(CO₃)₃, Ce₂(CO₃)₃, NaAl(CO₃) (OH)₂, and mixtures thereof, to name a few.

Optically transmissive vehicles include metal oxides, metal salts and metal silicates such as alumina (Al₂O₃), silica (SiO₂), zirconium oxide (ZrO₂), sodium silicate (Na₂SiO₃), potassium silicate (K₂SiO₃), and other compounds capable of optically transmitting laser energy (e.g., as generated from NdYAG, CO₂ and Yt fiber lasers).

Viscosity/fluidity enhancers include metal fluorides such as calcium fluoride (CaF₂), cryolite (Na₃AlF₆) and other agents known to enhance viscosity and/or fluidity (e.g., reduced viscosity with CaO, MgO, Na₂O, K₂O and increasing viscosity with Al₂O₃ and TiO₂) in welding applications.

Shielding agents include metal carbonates such as calcium carbonate (CaCO₃), aluminum carbonate (Al₂(CO₃)₃), dawsonite (NaAl(CO₃)(OH)₂), dolomite (CaMg(CO₃)₂), magnesium carbonate (MgCO₃), manganese carbonate (MnCO₃), cobalt carbonate (CoCO₃), nickel carbonate (NiCO₃), lanthanum carbonate (La₂(CO3)₃) and other agents known to form shielding and/or reducing gases (e.g., CO, CO₂, H₂).

Scavenging agents include metal oxides and fluorides such as calcium oxide (CaO), calcium fluoride (CaF₂), iron oxide (FeO), magnesium oxide (MgO), manganese oxides (MnO, MnO₂), niobium oxides (NbO, NbO₂, Nb₂O₅), titanium oxide (TiO₂), zirconium oxide (ZrO₂) and other agents known to react with detrimental elements such as sulfur and phosphorous to form low-density byproducts expected to “float” into a resulting slag layer 30.

Vectoring agents include titanium, zirconium, boron and aluminum containing compounds and materials such as titanium alloys (Ti), titanium oxide (TiO₂), titanite (CaTiSiO₅), aluminum alloys (Al), aluminum carbonate (Al₂(CO₃)₃), dawsonite (NaAl(CO₃)(OH)₂), borate minerals (e.g., kernite, borax, ulexite, colemanite), nickel titanium alloys (e.g., Nitinol), niobium oxides (NbO, NbO₂, Nb₂O₅) and other metal-containing compounds and materials used to supplement molten alloys with elements.

In some embodiments the flux composition 18 may also contain certain organic fluxing agents. Examples of organic compounds exhibiting flux characteristics include high-molecular weight hydrocarbons (e.g., beeswax, paraffin), allotropes of carbon (e.g., graphite), carbohydrates (e.g., cellulose), natural and synthetic oils (e.g., palm oil), organic reducing agents (e.g., charcoal, coke), carboxylic acids and dicarboxylic acids (e.g., abietic acid, isopimaric acid, neoabietic acid, dehydroabietic acid, rosins), carboxylic acid salts (e.g., rosin salts), carboxylic acid derivatives (e.g., dehydro-abietylamine), amines (e.g., triethanolamine), alcohols (e.g., high polyglycols, glycerols), natural and synthetic resins (e.g., polyol esters of fatty acids), mixtures of such compounds, and other organic compounds.

In some embodiments flux compositions of the present disclosure include:

5-60% by weight of metal oxide(s);

10-70% by weight of metal fluoride(s);

5-40% by weight of metal silicate(s); and

0-40% by weight of metal carbonate(s),

based on a total weight of the flux composition.

In some embodiments flux compositions of the present disclosure include:

5-40% by weight of Al₂O₃, SiO₂, and/or ZrO₂;

10-50% by weight of metal fluoride(s);

5-40% by weight of metal silicate(s);

0-40% by weight of metal carbonate(s); and

15-30% by weight of other metal oxide(s), based on a total weight of the flux composition.

In some embodiments flux compositions of the present disclosure include:

5-60% by weight of at least one of Al₂O₃, SiO₂, Na₂SiO₃ and K₂SiO₃;

10-50% by weight of at least one of CaF₂, Na₃AlF₆, Na₂O and K₂O;

1-30% by weight of at least one of CaCO₃, Al₂(CO₃)₃, NaAl(CO₃)(OF)₂, CaMg(CO₃)₂, MgCO₃, MnCO₃, CoCO₃, NiCO₃ and La₂(CO3)₃;

15-30% by weight of at least one of CaO, MgO, MnO, ZrO₂ and TiO₂; and

0-5% by weight of at least one of a Ti metal, an Al metal and CaTiSiO₅, based on a total weight of the flux composition.

In some embodiments the flux compositions of the present disclosure include:

5-40% by weight of Al₂O₃;

10-50% by weight of CaF₂;

5-30% by weight of SiO₂;

1-30% by weight of at least one of CaCO₃, MgCO₃ and MnCO₃;

15-30% by weight of at least two of CaO, MgO, MnO, ZrO₂ and TiO₂; and

0-5% by weight of at least one of Ti, Al, CaTiSiO₅, Al₂(CO₃)₃ and NaAl(CO₃)(OH)₂, based on a total weight of the flux composition.

In some embodiments the flux composition contains at least two compounds selected from a metal oxide, a metal halide, an oxometallate and a metal carbonate. In other embodiments the flux composition contains at least three of a metal oxide, a metal halide, an oxometallate and a metal carbonate. In still other embodiments the flux composition may contain a metal oxide, a metal halide, an oxometallate and a metal carbonate.

Viscosity of the molten slag may be increased by including at least one high melting-point metal oxide which can act as thickening agent. Thus, in some embodiments the flux composition is formulated to include at least one high melting-point metal oxide. Examples of high melting-point metal oxides include metal oxides having a melting point exceeding 2000° C.—such as Sc₂O₃, Cr₂O₃, Y₂O₃, ZrO₂, HfO₂, La₂O₃, Ce₂O₃, Al₂O₃ and CeO₂.

In some embodiments the flux compositions of the present disclosure include zirconia (ZrO₂) and at least one metal silicate, metal fluoride, metal carbonate, metal oxide (other than zirconia), or mixtures thereof. In such cases the content of zirconia is often greater than about 7.5 percent by weight, and often less than about 25 percent by weight. In other cases the content of zirconia is greater than about 10 percent by weight and less than 20 percent by weight. In still other cases the content of zirconia is greater than about 3.5 percent by weight, and less than about 15 percent by weight. In still other cases the content of zirconia is between about 8 percent by weight and about 12 percent by weight.

In some embodiments the flux compositions of the present disclosure include a metal carbide and at least one metal oxide, metal silicate, metal fluoride, metal carbonate, or mixtures thereof. In such cases the content of the metal carbide is less than about 10 percent by weight. In other cases the content of the metal carbide is equal to or greater than about 0.001 percent by weight and less than about 5 percent by weight. In still other cases the content of the metal carbide is greater than about 0.01 percent by weight and less than about 2 percent by weight. In still other cases the content of the metal carbide is between about 0.1 percent and about 3 percent by weight.

In some embodiments the flux compositions of the present disclosure include at least two metal carbonates and at least one metal oxide, metal silicate, metal fluoride, or mixtures thereof. For example, in some instances the flux compositions include calcium carbonate (for phosphorous control) and at least one of magnesium carbonate and manganese carbonate (for sulfur control). In other cases the flux compositions include calcium carbonate, magnesium carbonate and manganese carbonate. Some flux compositions comprise a ternary mixture of calcium carbonate, magnesium carbonate and manganese carbonate such that a proportion of the ternary mixture is equal to or less than 30% by weight relative to a total weight of the flux material. A combination of such carbonates (binary or ternary) is beneficial in most effectively scavenging multiple tramp elements.

All of the percentages (%) by weight enumerated above are based upon a total weight of the flux material being 100%.

In some embodiments commercially availed fluxes may be used such as those sold under the names Lincolnweld P2007, Bohler Soudokay NiCrW-412, ESAB OK 10.16 and 10.90, Special Metals NT100, Oerlikon OP76, Bavaria WP 380, Sandvik 50SW, 59S or SAS1, and Avesta 805. Such commercial fluxes may be ground to a smaller particle size range before use, such as a particle size range describe above.

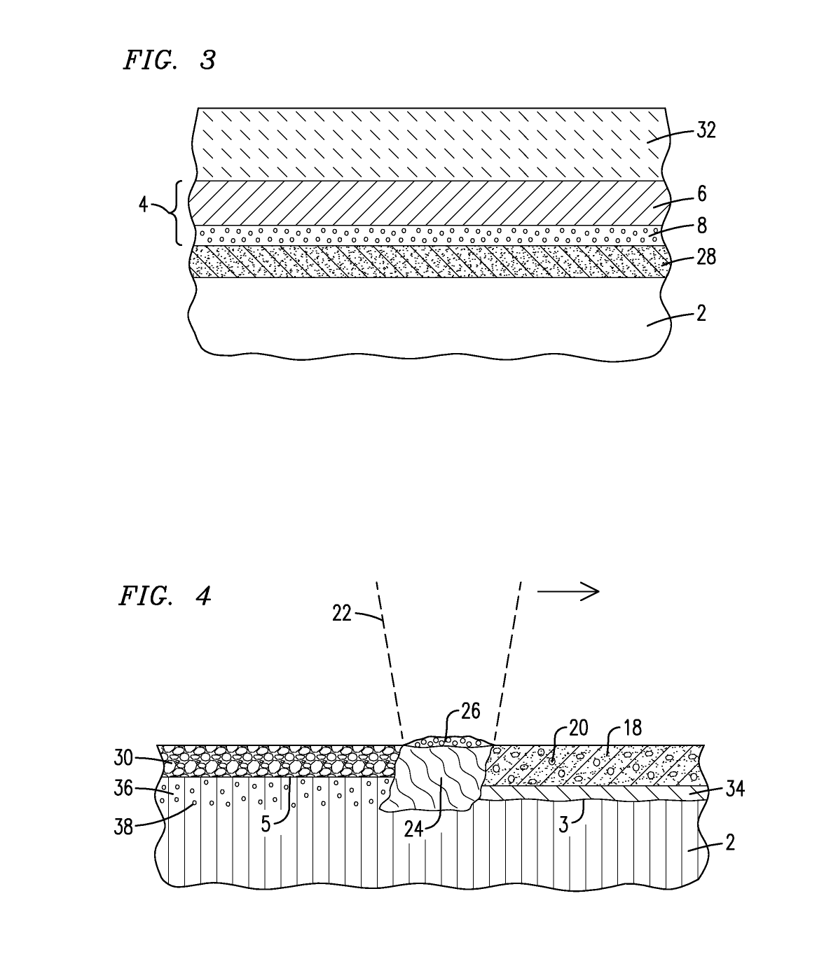

As explained above, following melt processing the melt-processed layer 28 may then be coated with a protective alloy layer to form a protective coating that imparts at least one protective characteristic (e.g., temperature resistance, chemical resistance) to a component fabricated from the resulting coated superalloy substrate. FIG. 3 illustrates one embodiment in which the melt-processed layer 28 is coated with an inner bond coat layer 4 and an outer thermal barrier coating 32 (often referred to collectively as a “thermal barrier coating system”). In other embodiments the melt-processed layer 28 may only be coated with an environmental coating (having the same composition as the bond coat layer 4) without an outer thermal barrier coating 32.

Suitable protective alloy layers 4 used to coat the melt-processed layer 28 may include diffusion coatings and overlay coatings known in the relevant art to be effective for protecting superalloy substrates against environmental attack. Such coatings generally contain relatively high proportions of aluminum and/or chromium, and are considered to be sacrificial coatings because they are attacked by environmental agents that would otherwise degrade the underlying superalloy substrate.

Diffusion coatings include nickel-aluminides (NiAI), cobalt-aluminides (CoAl) and platinum-aluminides (PtAI) which often contain various other metals such as chromium, silicon and other noble metals. Platinum-aluminide coatings may be two-phase coatings or one-phase coatings. Two-phase coatings contain a layer of platinum-aluminide particles (e.g., PtAl₂) on the surface of the superalloy substrate and a nickel-aluminide plus platinum layer ((Ni,Pt)AI) underneath. One-phase coatings contain a nickel-aluminide plus platinum layer ((Ni,Pt)AI) on the surface of the superalloy substrate. Diffusion coatings may be applied using a variety of techniques including pack cementation, vapor-phase aluminizing (VPA), chemical vapor deposition (CVD), and laser powder deposition. Platinum modified aluminides may be deposited using a three-step process involving electroplating a layer of platinum followed by inter-diffusion heat treatment under an inert atmosphere followed by a diffusion aluminizing process (pack or vapor phase). In some embodiments diffusion coatings may be applied using laser powder deposition in the presence of a flux composition as describe above. Flux compositions may be added to the metallic filler powder or may be included as a separate layer (generally placed on top of the metallic filler powder).

Overlay coatings may contain an alloy of the formula MCrAIX in which “M” represents Ni, Co, or a mixture thereof, and “X” represents Y, Hf, W, Zr, La, or a mixture thereof. MCrAIX coatings may be deposited using physical vapor deposition techniques such as electron-beam physical deposition (EBPVD), plasma spraying techniques such as low-pressure plasma spray (LPPS), inert-gas shrouded plasma spray deposition and very-low pressure plasma spray deposition, high-velocity oxyfuel (HVOF) deposition, high-velocity air fuel (HVAF) deposition, cold-gas dynamic spraying, and laser powder deposition. In some embodiments overlay coatings may be applied using laser powder deposition in the presence of a flux composition as describe above. Flux compositions may be added to the metallic filler powder or may be included as a separate layer (generally placed on top of the metallic filler powder).

Suitable thermal barrier coatings (TBCs) 32 used to coat the protective alloy layer 4 may include ceramic materials containing metal oxides such as zirconia (ZrO₂) which are often stabilized by adding a small proportion (such as about 8 wt. %) of another metal oxide such as yttria (Y₂O₃), magnesia (MgO), or other oxides. Some embodiments employ yttria-stabilized zirconias (YSZs) containing zirconia and a small proportion of yttria. TBCs may be deposited using techniques known in the relevant art such as air plasma spraying (APS), electron beam physical vapor deposition (EBPVD) and laser sintering. Typical TBC porosity ranges from about 5% to about 25% (often from about 10% to about 20%) to improve high strain compliance and to reduce thermal conductivity.

In the non-limiting illustration of FIG. 3, the melt-processed superalloy layer 28 is coated with a diffusion aluminide coating 4 comprising a metal aluminide layer 6 covering an inter-diffusion layer 8. The metal aluminide layer 6 is coated with a thermal barrier coating 32 which is a ceramic material containing, for example, a yttria-stabilized zirconia. Advantageously, the resulting coated superalloy substrate illustrated in FIG. 3 does not form a secondary reaction zone (SRZ) 12 containing elongated TCP phases 14 as shown in FIG. 1. While not being bound by any particular theory or mechanism, it is believed that melt processing of the surface can reduce or eliminate the formation of detrimental TCP phases 14 by eliminating surface asperities and/or internal stresses (such as cold work) that can serve as initiation points for TCP formation.

In some instances the melting and cooling steps are controlled such that the melt-processed superalloy layer 28 has an amorphous solid structure. In the non-limiting illustration of FIG. 3, for example, although the superalloy substrate 2 has a single-crystal structure the melt processing is controlled so that the resulting glazed layer 28 is amorphous. While not being bound by any particular theory or mechanism, it is believed that in some embodiments the formation of an amorphous interlayer 28 from a single-crystal or directionally-solidified substrate can further reduce or eliminate the formation of detrimental TCP phases 14 by removing points of nucleation for TCP formation. The solid form of the melt-processed layer 28 may be controlled, for example, by controlling the depth of the melt pool 24 and the cooling rate as described above.

In other embodiments the superalloy substrate 2 may have an amorphous solid structure, an equiaxed crystal structure, or a directionally-solidified (columnar) crystal structure—and the melt-processed layer 28 may have an amorphous or crystalline structure that is the same or different from the structure of the underlying superalloy substrate 2. Although the illustrative embodiment of FIG. 3 employs a single aluminide layer 6, in other embodiments the protective alloy layer may include more than one aluminide layer (same type or different types) or may include other types of alloy coatings such as MCrAIX coatings.

FIG. 4 depicts another embodiment in which a protective material 34 containing a carbon source is first applied onto a surface of a superalloy substrate 2, and then an energy beam 22 is traversed over the initially-coated surface to form a carbon-enriched melt pool 24 that is then allowed to cool and solidify into a carbon-enriched melt-processed alloy layer 36. As with the illustration of FIG. 2, surface asperities 3 contained on the superalloy substrate 2 can be eliminated by the melt processing such that a resulting solidified surface 5 is relatively free of physical incongruities and/or is relatively free of thermal stresses.

Additionally, the presence of the carbon-containing protective material 34 can also reduce or prevent the formation of a detrimental SRZ. While not being bound by any particular theory or mechanism, it is believed that the carbon enrichment of the melt pool 24 can lead to the formation of metal carbides 38 and thereby suppress the formation of elongated TCP phases. When such metal carbides 38 are formed from refractory elements that are often contained in superalloys (e.g., Re, W, Ta, Hf, No, Nb and Zr), it is believed that the effective lowering of the concentration of these elements can impede TCP nucleation and growth. Although it was previously known to introduce carbides to reduce SRZ formation, these techniques employ chemical vapor deposition which is slow, expensive, and cannot be applied to larger components.

The protective material 34 may contain a carbon source such as a hydrocarbon or an allotrope of carbon. Hydrocarbon sources may include high-molecular weight hydrocarbons such as beeswax and paraffin. Carbon is capable of forming many allotropes due to its electronic structure. Allotropes of carbon include structurally simple forms such as graphite, lonsdaleite, coke, carbon black (amorphous carbon), glassy (vitreous) carbon and diamond, as well as structurally more complex forms such as graphene, fullerenes, carbon nanotubes and carbon nanofoams, to name a few. In the non-limiting illustration of FIG. 4 the protective material 34 may be deposited, for example, by spraying the surface of the superalloy substrate 2 with a graphite-containing aerosol.

Alternately, or in addition thereto, the melt processing of FIG. 4 may be performed in the presence of a flux composition 18 applied, for example, to the surface of the protective material 34 or directly to the surface of the superalloy substrate 2. As explained above, the flux composition and the resulting slag layer 30 may provide a number of beneficial functions such as shielding the melt pool 24 and the melt-processed alloy layer 36 from atmospheric reagents, insulating the melt-processed layer 36 to control the cooling/solidifying process, shaping and supporting the melt pool 24, removing trace impurities from the melt pool 24, enhancing heat absorption from the energy beam 22, and compensating for loss of volatilized or reacted elements that may occur during the melt processing. Moreover, in this application the slag may enhance smoothness of the glazed layer, and the flux may contribute to carbon and/or carbides in the near surface region—thereby reducing secondary reaction zone (SRZ) formation. Optionally, carbon may be pre-introduced onto the process surface 3 by pre-spraying with a dry graphite lubricant. In the embodiment of FIG. 4 the flux composition 18 is formulated to contain a shielding agent 20 which generates at least one shielding gas upon exposure to laser photons or heating. In some embodiments shielding gases may coalesce into a gaseous envelope 26 covering the melt pool 24, as illustrated in FIG. 4. In other embodiments the protective material 34 may be substituted for a flux composition 18 containing a carbon source such as an allotrope of carbon (e.g., graphite, carbon black, etc.), a hydrocarbon, or a metal carbide, to name a few.

Embodiments employing a carbon-containing protective material 34 may provide an additional benefit relative to melt processing methods without carbon enrichment. As explained above, it may in some circumstances be advantageous to control the melting and cooling steps in order to obtain a melt-processed superalloy layer 28 having an amorphous structure. In other cases, however, when it may be advantageous to generate a melt processed alloy layer having a crystalline structure, use of the protective material 34 containing a carbon source may provide comparable protection against the formation of a detrimental SRZ.

FIG. 4 illustrates one such embodiment wherein the superalloy substrate 2 is in the form of a directionally-solidified (columnar) substrate, and the melting and cooling steps are controlled such that the resulting carbon-enriched melt-processed alloy layer 36 undergoes directional solidification to emulate the structure of the underlying substrate 2. Whereas, the presence of columnar crystal grains may be expected initiate (and thereby increase) the formation of the elongated TCP phases 14 shown in FIG. 1, in the embodiment of FIG. 4 such detrimental TCP phases may be mitigated through the formation of metal carbides 38 by carbon enrichment of the melt-processed layer 36. As explained above, such metal carbides 38 may suppress the formation of elongated TCP phases 14 by effectively reducing the concentration of certain refractory elements.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A coating method, comprising:
melting a surface of a superalloy substrate with an energy beam to form a melt pool;
allowing the melt pool to cool and solidify into a melt-processed superalloy layer bonded to the superalloy substrate; and
coating the melt-processed superalloy layer with a protective alloy layer, to form a coated substrate.

2. The method of claim 2, further comprising:
before the melting, depositing a flux composition onto the surface of the superalloy substrate, such that the melting of the surface also melts the flux composition and the cooling of the melt pool also forms a slag layer at least partially covering the melt-processed superalloy layer; and
before the coating, removing the slag layer at least partially covering the melt-processed superalloy layer.

3. The method of claim 2, wherein the flux composition comprises at least one selected from the group consisting of a metal oxide, a metal halide, an oxometallate, a metal carbonate, a hydrocarbon, an allotrope of carbon, a carbohydrate, a natural oil, a synthetic oil, an organic reducing agent, a carboxylic acid, a dicarboxylic acid, a carboxylic acid salt, a carboxylic acid derivative, an amine, an alcohol, a natural resin and a synthetic resin.

4. The method of claim 2, wherein the flux composition comprises:
a metal oxide selected from the group consisting of Li₂O, BeO, B₂O₃, B₆O, MgO, Al₂O₃, SiO₂, CaO, Sc₂O₃, TiO, TiO₂, Ti₂O₃, VO, V₂O₃, V₂O₄, V₂O₆, Cr₂O₃, CrO₃, MnO, MnO₂, Mn₂O₃, Mn₃O₄, FeO, Fe₂O₃, Fe₃O₄, CoO, Co₃O₄, NiO, Ni₂O₃, Cu₂O, CuO, ZnO, Ga₂O₃, GeO₂, As₂O₃, Rb₂O, SrO, Y₂O₃, ZrO₂, NiO, NiO₂, Ni₂O₅, MoO₃, MoO₂, RuO₂, Rh₂O₃, RhO₂, PdO, Ag₂O, CdO, In₂O₃, SnO, SnO₂, Sb₂O₃, TeO₂, TeO₃, Cs₂O, BaO, HfO₂, Ta₂O₅, WO₂, WO₃, ReO₃, Re₂O₇, PtO₂, Au₂O₃, La₂O₃, CeO₂, Ce₂O₃, and mixtures thereof; and
at least one of:
(i) a metal halide selected from the group consisting of LiF, LiCI, LiBr, LiI, Li₂NiBr₄, Li₂CuCl₄, LiAsF₆, LiPF₆, LiAlCl₄, LiGaCl₄, Li₂PdCl₄, NaF, NaCl, NaBr, Na₃AlF₆, NaSbF₆, NaAsF₆, NaAuBr₄, NaAlCl₄, Na₂PdCl₄, Na₂PtCl₄, MgF₂, MgCl₂, MgBr₂, AlF₃, KCl, KF, KBr, K₂RuCl₅, K₂IrCl₆, K₂PtCl₆, K₂PtCl₆, K₂ReCl₆, K₃RhCl₆, KSbF₆, KAsF₆, K₂NiF₆, K₂TiF₆, K₂ZrF₆, K₂Ptl₆, KAuBr₄, K₂PdBr₄, K₂PdCl₄, CaF₂, CaF, CaBr₂, CaCl₂, Cal₂, ScBr₃, ScCl₃, ScF₃, ScI₃, TiF₃, VCl₂, VCl₃, CrCl₃, CrBr₃, CrCl₂, CrF₂, MnCl₂, MnBr₂, MnF₂, MnF₃, Mnl₂, FeBr₂, FeBr₃, FeCl₂, FeCl₃, Fel₂, CoBr₂, CoCl₂, CoF₃, CoF₂, Col₂, NiBr₂, NiCl₂, NiF₂, Nil₂, CuBr, CuBr₂, CuCl, CuCl₂, CuF₂, Cul, ZnF₂, ZnBr₂, ZnCl₂, Znl₂, GaBr₃, Ga₂Cl₄, GaCl₃, GaF₃, GaI₃, GaBr₂, GeBr₂, GeI₂, GeI₄, RbBr, RbCl, RbF, RbI, SrBr₂, SrCl₂, SrF₂, SrI₂, YCl₃, YF₃, YI₃, YBr₃, ZrBr₄, ZrCl₄, ZrI₂, YBr, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, AgCl, AgF, Ag F₂, AgSbF₆, AgI, CdBr₂, CdCl₂, CdI₂, InBr, InBr₃, InCl, InCl₂, InCl₃, InF₃, InI, InI₃, SnBr₂, SnCl₂, Snl₂, Snl₄, SnCl₃, SbF₃, SbI₃, CsBr, CsCl, CsF, CsI, BaCl₂, BaF₂, Bal₂, BaCoF₄, BaNiF₄, HfCl₄, HfF₄, TaCl₅, TaF₅, WCl₄, WCl₆, ReCl₃, ReCl₅, IrCl₃, PtBr₂, PtCl₂, AuBr₃, AuCl, AuCl₃, AuI, KAuCl₄, LaBr₃, LaCl₃, LaF₃, LaI₃, CeBr₃, CeCl₃, CeF₃, CeF₄, CeI₃, and mixtures thereof;
(ii) an oxometallate selected from the group consisting of LiIO₃, LiBO₂, Li₂SiO₃, LiClO₄, Na₂B₄O₇, NaBO₃, Na₂SiO₃, NaVO₃, Na₂MoO₄, Na₂SeO₄, Na₂SeO₃, Na₂TeO₃, K₂SiO₃, K₂CrO₄, K₂Cr2O₇, CaSiO₃, BaMnO₄, and mixtures thereof; and
(iii) a metal carbonate selected from the group consisting of Li₂CO₃, Na₂CO₃, NaHCO₃, MgCO₃, K₂CO₃, CaCO₃, Cr₂(CO₃)₃, MnCO₃, CoCO₃, NiCO₃, CuCO₃, Rb₂CO₃, SrCO₃, Y₂(CO3)₃, Ag₂CO₃, CdCO₃, In₂(CO₃)₃, Sb₂(CO₃)₃, O₂CO₃, BaCO₃, La₂(CO₃)₃, Ce₂(CO₃)₃, NaAl(CO₃) (OH)₂, and mixtures thereof.

5. The method of claim 2, wherein the flux composition comprises:
5-60% by weight of at least one of selected from the group consisting of Al₂O₃, SiO₂, Na₂SiO₃ and K₂SiO₃;
10-50% by weight of at least one selected from the group consisting of CaF₂, Na₃AlF₆, Na₂O and K₂O;
1-30% by weight of at least one selected from the group consisting of CaCO₃, Al₂(CO₃)₃, NaAl(CO₃)(OH)₂, CaMg(CO₃)₂, MgCO₃, MnCO₃, CoCO₃, NiCO₃ and La₂(CO3)₃;
15-30% by weight of at least one selected from the group consisting of CaO, MgO, MnO, ZrO₂ and TiO₂; and
0-5% by weight of at least one selected from the group consisting of a Ti metal, an Al metal, TiO₂ and CaTiSiO₅ relative to a total weight of the flux composition.

6. The method of claim 1, further comprising controlling the melting and the cooling such that the melt-processed superalloy layer is an amorphous superalloy layer.

7. The method of claim 1, wherein:
the superalloy substrate has a solid structure selected from the group consisting of an equiaxed crystal structure, a directionally-solidified crystal structure and a single crystal structure; and
the melting and the cooling are controlled such that the melt-processed superalloy layer has an amorphous solid structure.

8. The method of claim 1, wherein:
the superalloy substrate has a single crystal structure; and
the melting and the cooling are controlled such that the melt-processed superalloy layer has an amorphous solid structure.

9. The method of claim 1, wherein the protective alloy layer comprises at least one alloy selected from the group consisting of a nickel aluminide, a cobalt aluminide, a platinum aluminide, a platinum alloy and an MCrAIX alloy in which:
M represents an element selected from the group consisting of Co, Ni, and a mixture thereof, and
X represents an element selected from the group consisting of Y, Hf, W, Zr La, and a mixture thereof.

10. The method of claim 1, further comprising coating the protective alloy layer with a thermal barrier coating, to form a thermally-protective coating comprising the thermal barrier coating bonded to the protective alloy layer.

11. The method of claim 10, wherein:
the protective alloy layer comprises at least one alloy selected from the group consisting of a nickel aluminide, a cobalt aluminide, a platinum aluminide, a platinum alloy and an MCrAIX alloy in which,
M represents an element selected from the group consisting of Co, Ni, and a mixture thereof, and
X represents an element selected from the group consisting of Y, Hf, W, Zr La, and a mixture thereof; and
the thermal barrier coating is a ceramic coating comprising zirconia.

12. The method of claim 2, wherein:
the flux composition comprises an allotrope of carbon or a hydrocarbon; and
a proportion of carbon contained in the melt-processed superalloy layer is higher than a proportion of carbon contained in the superalloy material.

13. The method of claim 1, further comprising:
before the melting, depositing a protective material comprising an allotrope of carbon onto the surface of the superalloy substrate, such that the melting of the surface forms a carbon-enriched melt pool and the cooling forms a carbon-enriched melt-processed alloy layer,
wherein a proportion of carbon contained in the carbon-enriched melt-processed alloy layer is higher than a proportion of carbon contained in the superalloy substrate.

14. The method of claim 13, wherein the protective material is deposited by spraying the surface of the superalloy substrate with a graphite-containing aerosol or with a dry graphite lubricant.

15. The method of claim 13, wherein:
the superalloy substrate has a directionally-solidified crystal structure or a single crystal structure; and
the melting and the cooling are controlled such that the carbon-enriched melt-processed alloy layer has an amorphous solid structure or a directionally-solidified solid structure.

16. The method of claim 13, further comprising:
coating the protective alloy layer with a thermal barrier coating, to form a thermally-protective coating comprising the thermal barrier coating bonded to the protective alloy layer,
wherein:
the protective alloy layer comprises at least one alloy selected from the group consisting of a nickel aluminide, a cobalt aluminide, a platinum aluminide, a platinum alloy and an MCrAIX alloy in which,
M represents an element selected from the group consisting of Co, Ni, and a mixture thereof, and
X represents an element selected from the group consisting of Y, Hf, W, Zr La, and a mixture thereof; and
the thermal barrier coating is a ceramic coating comprising zirconia.

17. A coated superalloy substrate obtained by the method of claim 1.

18. A coated superalloy substrate obtained by the method of claim 13.

19. A method, comprising laser glazing a surface of a superalloy substrate and then coating a resulting amorphous surface with a platinum aluminide to form a first diffusion-coated superalloy exhibiting a greater resistance to formation of detrimental phase instabilities than a second diffusion-coated superalloy formed by coating the superalloy substrate directly with the platinum aluminide without performing the laser glazing.

20. The method of claim 19, further comprising painting or spraying the surface of the superalloy substrate with a graphite-containing aerosol or with a dry graphite lubricant before performing the laser glazing.
